(19) United States
(12) Patent Application Publication
(10) Pub. No.: US 2017/0154513 A1
(43) Pub. Date: Jun. 1, 2017

(54) Systems And Methods For Automatic Detection Of An Occupant Condition In A Vehicle Based On Data Aggregation

(71) Applicant: FARADAY&FUTURE INC., Gardena, CA (US)

(72) Inventor: Mohamad Mwaffak Hariri, Anaheim, CA (US)

(73) Assignee: FARADAY&FUTURE INC., Gardena, CA (US)

(21) Appl. No.: 15/364,436

(22) Filed: Nov. 30, 2016

Related U.S. Application Data
(60) Provisional application No. 62/261,216, filed on Nov. 30, 2015.

(51) Int. Cl. G08B 21/02; B60N 2/00

(52) U.S. Cl. CPC G08B 21/02; B60N 2/002

(57) ABSTRACT

A system for detecting a condition associated with an occupant in a vehicle. The system may include a plurality of sensors configured to acquire a first set of data indicative of occupancy of the vehicle and a second set of data indicative of at least one operating status of the vehicle, and at least one controller. The at least one controller may be configured to aggregate the first set of data and the second set of data, automatically determine the condition associated with the occupant in the vehicle based on the aggregated data, and generate a notification based on the condition.

### CROSS-REFERENCE TO RELATED APPLICATIONS

This application claims the benefit of U.S. Provisional Application No. 62/261,216, filed on Nov. 30, 2015. The subject matter of the aforementioned application is incorporated herein by reference.

### TECHNICAL FIELD

The present disclosure relates generally to systems and methods for detecting operation status in a vehicle, and more particularly, to systems and methods for automatically detecting an occupant condition in a vehicle based on data aggregation.

### BACKGROUND

There are many circumstances that arise when abnormal situations may occur in a vehicle. For instance, an owner of the vehicle may provide access of the vehicle to other people (e.g., a teenager or an elderly relative), who are more likely to have unsafe driving behaviors. In one example, the operator may be a teenager that has tendencies of texting while driving, which could create safety concerns and may go unnoticed. In another example, an elderly relative may be operating the vehicle and suffer from sudden health problems.

Under these circumstances it may be desirable to ensure that the abnormal situation is automatically detected and immediately brought to the attention of the operator of the vehicle, or sometimes, a person outside the vehicle. Conventional detection methods usually rely on sensor designed to detect specific situations, or sometimes require observation and input by the operator or other occupants in the vehicle, to detect the abnormal situation. For example, a weight sensor is used to measure the weight on a seat and provide a warning if the weight measured is substantial but the seat belt is not buckled. However, such conventional methods cannot automatically detect driving behavior issues, such as texting while driving, driving under the influence, speeding, or that the operator is suffering from health problems.

The disclosed control system is directed to mitigating or overcoming one or more of the problems set forth above and/or other problems in the prior art.

### SUMMARY

One aspect of the present disclosure is directed to a control system for detecting a condition associated with an occupant in a vehicle. The system may include a plurality of sensors configured to acquire a first set of data indicative of occupancy of the vehicle and a second set of data indicative of at least one operating status of the vehicle, and at least one controller. The at least one controller may be configured to aggregate the first set of data and the second set of data, automatically determine the condition associated with the occupant in the vehicle based on the aggregated data, and generate a notification based on the condition.

Another aspect of the present disclosure is directed to a method for detecting a condition associated with an occupant in a vehicle. The method may include aggregating a first set of data indicative of occupancy of the vehicle and a second set of data indicative of at least one operating status of the vehicle, automatically determining a condition associated with the occupant in the vehicle based on the aggregated data, and generating a notification based on the condition.

Yet another aspect of the present disclosure is directed to a vehicle. The vehicle may include a seat configured to accommodate an occupant, a plurality of sensors configured to acquire a first set of data indicative of occupancy of the vehicle and a second set of data indicative of at least one operating status of the vehicle, and at least one controller. The at least one controller may be configured to aggregate the first and second sets of data, automatically determine a condition associated with the occupant in the vehicle based on the aggregated data, and generate a notification based on the condition.

### BRIEF DESCRIPTION OF THE DRAWINGS

FIG. 1 is a diagrammatic illustration of an exemplary embodiment of an exemplary vehicle.

FIG. 2 is a diagrammatic illustration of an exemplary embodiment of an interior of the exemplary vehicle of FIG. 1.

FIG. 3 is a block diagram of an exemplary control system that may be used with the exemplary vehicle of FIGS. 1-2, according to an exemplary embodiment of the disclosure.

FIG. 4 is an illustration of condition detection based on data aggregation that may be performed by the exemplary control system of FIG. 3, according to an exemplary embodiment of the disclosure.

FIG. 5 is a flowchart illustrating an exemplary process that may be performed by the exemplary control system of FIG. 3, according to an exemplary embodiment of the disclosure.

### DETAILED DESCRIPTION

The disclosure is generally directed to a control system for automatically detecting conditions in a vehicle based on data aggregation. The control system may include a plurality of sensors configured to acquire a first set of data indicative of occupancy of the vehicle and a second set of data indicative of at least one operating status of the vehicle. The control system may be configured to aggregate the first and second sets of data, and determine the conditions based on the aggregation of data. The conditions may be determined based on an identity of an occupant, and the control system may be configured to generate and transmit notifications based on the determined conditions.

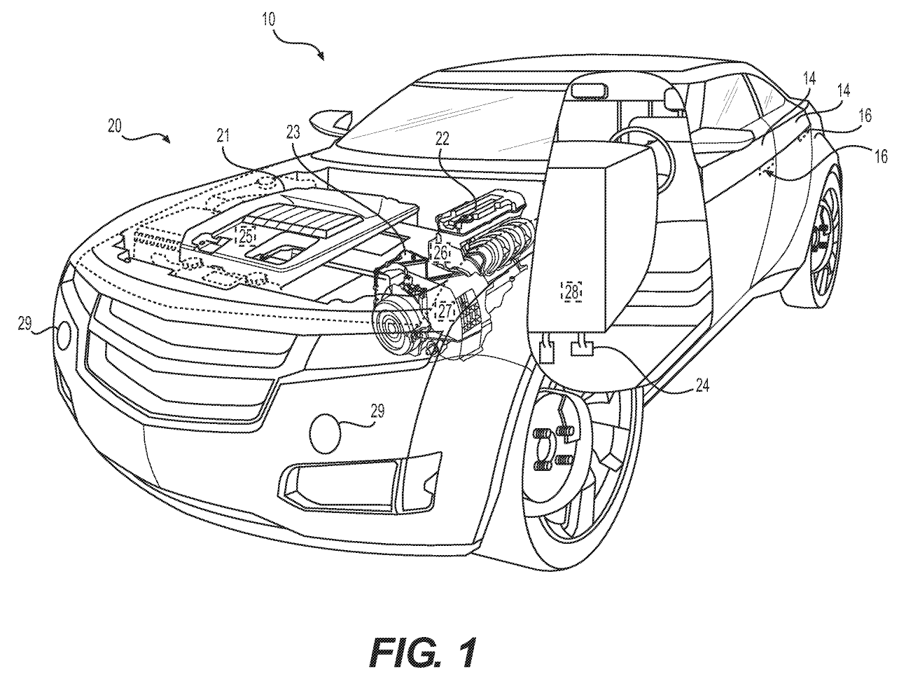

FIG. 1 is a diagrammatic illustration of an exemplary embodiment of an exemplary vehicle 10. Vehicle 10 may have any body style, such as a sports car, a coupe, a sedan, a pick-up truck, a station wagon, a sports utility vehicle (SUV), a minivan, or a conversion van. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomously operated. As illustrated in FIG. 1, vehicle 10 may include a plurality of doors 14 that allow access to an interior and each secured with respective locks 16. Each door 14 and/or lock 16 may be associated with a sensor configured to determine a status of the component.

Vehicle 10 may also include a powertrain 20 having a power source 21, a motor 22, and a transmission 23. In some embodiments, power source 21 may be configured to output power to motor 22, which drives transmission 23 to generate kinetic energy through a rotating axle of vehicle 10. Power source 21 may also be configured to provide power to other components of vehicle 10, such as audio systems, user interfaces, heating, ventilation, air conditioning (HVAC), etc. Power source 21 may include a plug-in battery or a hydrogen fuel-cell. It is also contemplated that in some embodiments powertrain 20 may include or be replaced by a conventional internal combustion engine. Vehicle 10 may also include a braking system 24 which may be configured to slow or stop a motion of vehicle 10 by reducing the kinetic energy. For example, braking system 24 may include brake pads having a wear surface that engages the rotating axle to inhibit rotation. In some embodiments, braking system 24 may be configured to convert the kinetic energy into electric energy to be stored for later use.

Each component of powertrain 20 and braking system 24 may be functionally associated with a sensor to detect a parameter of vehicle 10 and generate an operating signal. For example, power source 21, may be associated with a power source sensor 25, motor 22 may be functionally associated with one or more motor sensors 26, transmission 23 may be associated with a transmission sensor 27, and braking system 24 may be associated with a brake sensor 28. One or more of sensors 25-28 may be configured to detect parameters, such as state of charge, vehicle speed, vehicle acceleration, differential speed, braking frequency, and/or steering. Vehicle 10 may also include one or more proximity sensors 29 configured to generate a signal based on the proximity of objects (e.g., other vehicles) around vehicle 10.

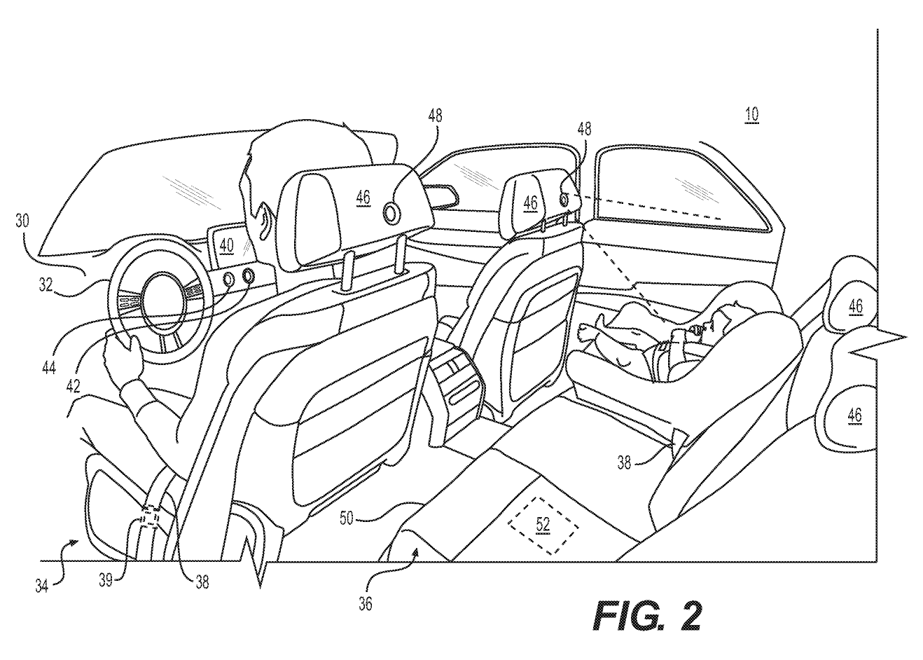

FIG. 2 is a diagrammatic illustration of an exemplary embodiment of an interior of the exemplary vehicle of FIG. 1. As illustrated in FIG. 2, vehicle 10 may include a dashboard 30 that may house or support a steering wheel 32 and a user interface 40.

Vehicle 10 may also include one or more front seats 34 and one or more back seats 36. At least one of seats 34, 36 may accommodate a child car seat to support an occupant of a younger age and/or smaller size. Each seat 34, 36 may also be equipped with a seat belt 38 configured to secure an occupant. Vehicle 10 may also have various electronics installed therein to transmit and receive data related to the occupants. For example, dashboard 30 may house or support a microphone 42, a front camera 44, and a rear camera 48. Each seat belt 38 may have a buckle functionally associated with a seat belt sensor 39 configured to generate a signal indicative of the status of seat belt 38.

Front camera 44 and rear camera 48 may include any device configured to capture images of the interior of vehicle 10 and generate a signal to be processed to visually detect the presence of occupants of vehicle 10. For example, cameras 44, 48 may be used in conjunction with image recognition software, such that the software may distinguish a person from inanimate objects, and may determine an identity of certain people based on physical appearances. In some embodiments, the image recognition software may include facial recognition software and may be configured to recognize facial features and determine the age (e.g., by determining size and facial features) of occupants based on the images. The image recognition software may also be configured to recognize gestures, such as head movement, eye movement, eye closure, dilated pupils, glossy eyes, hands removed from steering wheel 32, and/or hands performing other tasks, such as eating, holding a cell phone, and/or texting. The image recognition software may also be configured to detect characteristics of animals. Cameras 44, 48 may be configured to be adjusted by a motor (not shown) to improve an image of the occupant. For example, the motor may be configured to tilt cameras 44, 48 in a horizontal and/or vertical plane to substantially center the occupant(s) in the frame. The motor may also be configured to adjust the focal point of the cameras 44, 48 to substantially focus on the facial features of the occupant(s).

Front camera 44 may be in a number of positions and at different angles to capture images of an operator (e.g., driver) and/or occupants of front seat 34. For example, front camera 44 may be located on dashboard 30, but may, additionally or alternatively, be positioned at a variety of other locations, such as on steering wheel 32, a windshield, and/or on structural pillars of vehicle 10. Rear cameras 48 may be directed forward and/or backward on any number of seats 34, 36 to capture facial features of occupants in back seat 36 facing either forward or backward. For example, as depicted in FIG. 1, vehicle 10 may include rear cameras 48 on a back of each headrest 46 of front seats 34. Vehicle 10 may also include cameras at a variety of other locations, such as, on a ceiling, doors, a floor, and/or other locations on seats 34, 36 in order to capture images of occupants of back seat 36. Vehicle 10 may, additionally or alternatively, include a dome camera positioned on the ceiling and configured to capture a substantially 360° image of the interior of vehicle 10.

Each seat 34, 36 may also include a weight sensor 52 configured to generate a weight signal based on a weight placed on each seat 34, 36. As depicted in FIG. 1, weight sensor 52 may be incorporated within the interior of seats 34, 36. Weight sensor 52 may embody a strain gauge sensor configured to determine a change in resistance based on an applied weight. Weight sensor 52 may be incorporated into a support 50 of seats 34, 36 or may be a separate component. For example, weight sensor 52 may be incorporated into a child car seat.

User interface 40 may be configured to receive input from the user and transmit data. For example, user interface 40 may have a display including an LCD, an LED, a plasma display, or any other type of display, and provide a Graphical User Interface (GUI) presented on the display for user input and data display. User interface 40 may further include input devices, such as a touchscreen, a keyboard, a mouse, and/or a tracker ball. User interface 40 may further include a housing having grooves containing the input devices and configured to receive individual fingers of the user. User interface 40 may be configured to receive user-defined settings. User interface 40 may also be configured to receive physical characteristics of common occupants (e.g., children) of back seat 36. For example, user interface 40 may be configured to receive an indicative weight or an indicative image of one or more children that often sit in back seat 36. User interface 40 may further include common car speakers and/or separate speakers configured to transmit audio.

Microphone 42 may include any structure configured to capture audio and generate audio signals (e.g., recordings) of interior of vehicle 10. As depicted in FIG. 1, microphone 42 may be centrally located on dashboard 30 to capture audio and responsively generate an audio signal in order to control various components of vehicle 10. For example, microphone 42 may be configured to capture voice commands from the operator. Microphone 42 may also be configured to capture audio from occupants of back seat 36.

It is contemplated that vehicle 10 may include additional sensors other than powertrain sensors 25-27, brake sensor 28, seat belt sensor 39, user interface 40, microphone 42, cameras 44, 48, and weight sensor 52, described above. For example, vehicle 10 may further include biometric sensors (not shown) configured to capture biometric data (e.g., fingerprints) of vehicle occupants. For example, in some embodiments, biometric sensors may be provided on doors 14 and configured to determine the identity of occupants as they enter into interior of vehicle 10. In some embodiments, biometric sensors may be placed on steering wheel 32 and configured to determine the identity of a driver that grasp steering wheel 32. In some embodiments, biometric sensors may be placed on user interface 40 and configured to determine the identity of occupants that manipulate user interface 40.

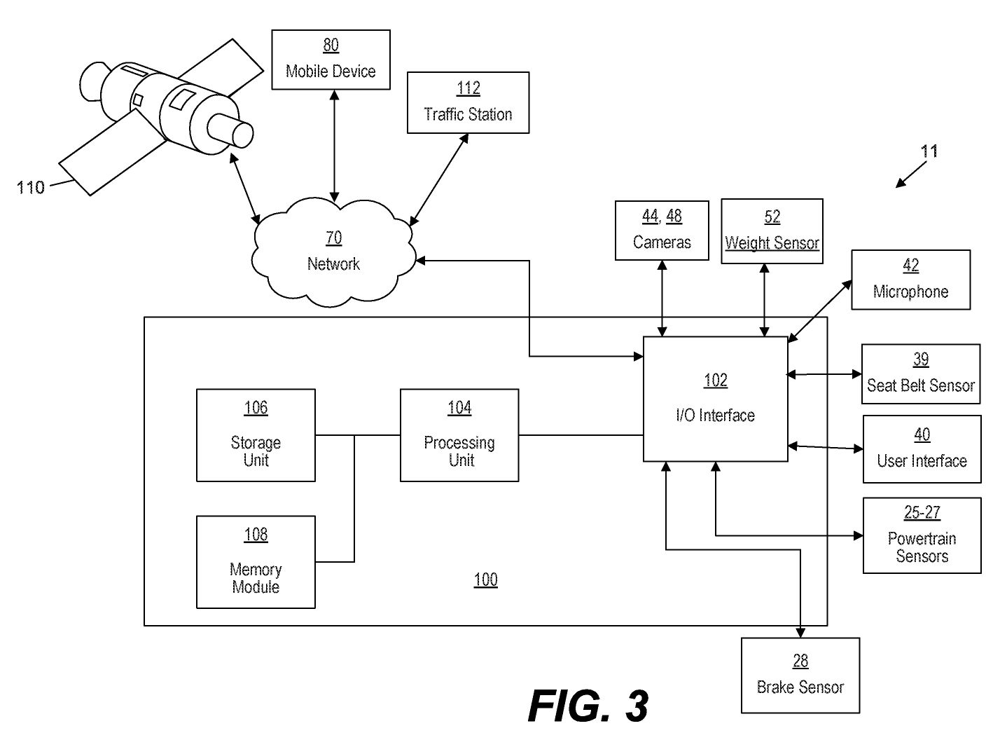

FIG. 3 provides a block diagram of an exemplary control system 11 that may be used in accordance with controlling operation of vehicle 10. As illustrated in FIG. 3, control system 11 may include a centralized controller 100 having, among other things, an I/O interface 102, a processing unit 104, a storage unit 106, and a memory module 108. One or more of the components of each controller 100 may be installed in an on-board computer of vehicle 10. These units may be configured to transfer data and send or receive instructions between or among each other.

I/O interface 102 may also be configured for two-way communication between controller 100 and various components of control system 11, such as powertrain sensors 25-27, brake sensor 28, seat belt sensor 39, user interface 40, microphone 42, cameras 44, 48, and weight sensor 52. I/O interface may also send and receive operating signals to and from mobile device 80, a satellite 110, and a traffic station 112. I/O interface 102 may send and receive the data between each of the devices via communication cables, wireless networks, or other communication mediums. For example, mobile device 80 may be configured to send and receive signals to I/O interface 102 via a network 70. Network 70 may be any type of wired or wireless network that may allow transmitting and receiving data. For example, network 70 may be a nationwide cellular network, a local wireless network (e.g., Bluetooth™, WiFi, or LiFi), and/or a wired network. Processing unit 104 may be configured to receive signals and process the signals to determine a plurality of conditions of vehicle 10. Processing unit 104 may also be configured to generate and transmit command signals, via I/O interface 102, in order to actuate the devices in communication.

Storage unit 106 and/or memory module 108 may be configured to store one or more computer programs that may be executed by controller 100 to perform functions of control system 11. For example, storage unit 106 and/or memory module 108 may be configured to store biometric data detection and processing software configured to determine the identity of individuals based on fingerprint(s). Storage unit 106 and/or memory module 108 may be further configured to store data and/or look-up tables used by processing unit 104. For example, storage unit 106 and/or memory module 108 may be configured to include data profiles of people related to vehicle 10.

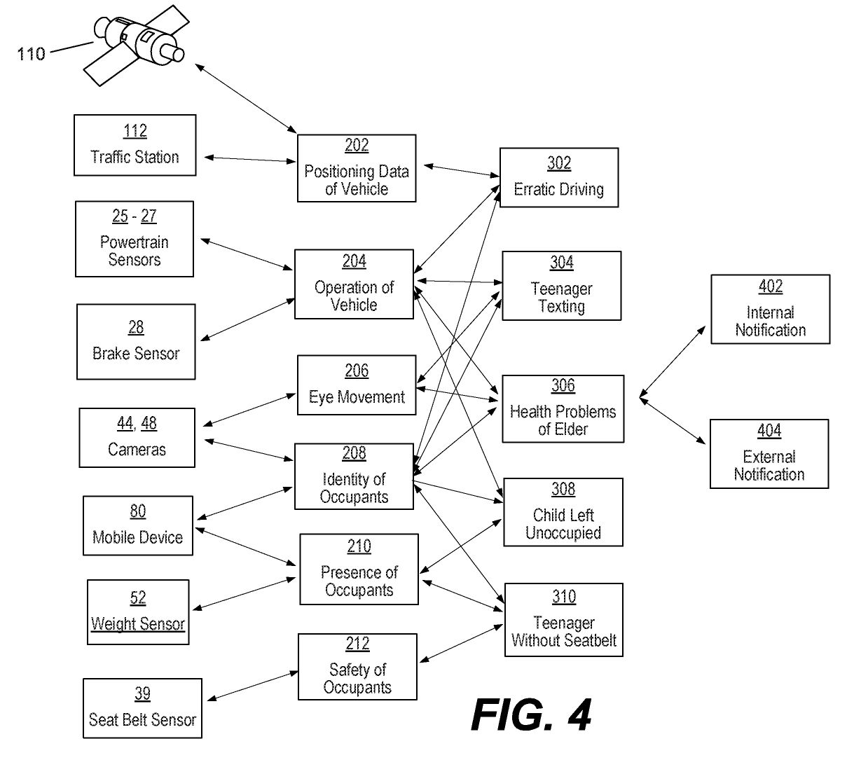

FIG. 4 is an illustration of condition detection based on data aggregation that may be performed by the exemplary control system 11. Control system 11 may receive sensor data from various in-vehicle sensors including, for example, powertrain sensors 25-27, brake system sensor 28, seat belt sensor 39, user interface 40, microphone 42, cameras 44, 48, and/or weight sensor 52. Control system 11 may further receive remote data from external sources such as satellite 110, traffic station 112, and/or mobile device 80.

Control system 11 may determine feature data 202-212 based on aggregated sensor data and/or remote data. In some embodiments, control system 11 may perform a feature extraction from the received data to extract certain feature data 202-212. For example, feature data 202 of vehicle 10 may be extracted from data aggregated from satellite 110 and/or traffic station 112. In some embodiments, control system 11 may also aggregate and process data from a variety of internal components. For example, controller 100 may also extract feature data 202 from data aggregated from proximity sensors 29. Controller 100 may be configured to aggregate operation data of vehicle 10 from components such as powertrain sensors 25-27 and brake sensors 28, and determine operation of vehicle feature data 204. Controller 100 may be configured to aggregate data related to eye movement from cameras 44, 48, and determine eye movement feature data 206. Controller 100 may be configured to aggregate data related to the identity of occupants from components such as cameras 44, 48 and mobile device 80, and determine identity of occupants feature data 208. Controller 100 may be configured to aggregate data related to the presence of occupants from components such as mobile device 80 and weight sensor 52, and determine presence of occupants feature data 210. Controller may also be configured to aggregate data related to the safety of occupants from components such as seat belt sensor 39, and determine safety of occupants feature data 212.

The aggregated data may be transformed into common parameters and fused. Fusing the signals may ensure increased accuracy and richer context. For example, signals from powertrain sensors 25-27 and brake sensor 28 may be transformed into common parameters, such as speed, acceleration, and degree of braking of vehicle 10. Fusing the signals from sensors 25-28 may advantageously provide richer context of the operation of vehicle 10, such as the degree of rate of braking at different rates of speed. Comparing the rate of breaking to collected data from the sensors 25-28, controller 100 may then extract a feature (e.g., the operator is braking too hard while driving on the highway). The feature may then be processed by controller 100.

Aggregated data may also be based on a variety of redundant components. For example, controller 100 may be configured to receive a variety of different components in order to determine an identity of an occupant. In some embodiments, controller 100 may be configured to determine the presence of specific occupants based on a digital signature from mobile device 80. The digital signature of communication device 80 may include a determinative emitted radio frequency (RF), Global Positioning System (GPS), Bluetooth™, and/or WiFi unique identifier. Controller 100 may be configured to relate the digital signature to stored data including the occupant's name and the occupant's relationship with vehicle 10. In some embodiments, controller 100 may be configured to determine the presence of o within vehicle 10 by GPS tracking software of mobile device 80. In some embodiments, vehicle 10 may be configured to detect mobile devices 80 upon connection to local network 70 (e.g., Bluetooth™, WiFi, or LiFi). In some embodiments, controller 100 may be configured to recognize occupants of vehicle 10 by receiving inputs into user interface 40. For example, user interface 40 may be configured to receive direct inputs of the identities of the occupants. User interface 40 may also be configured to receive biometric data (e.g., fingerprints) from occupants interacting with user interface 40. In some embodiments, controller 100 may be further configured to determine identities of occupants by actuating cameras 44, 48 to capture an image and process the image with facial recognition software.

Redundancy of the one or more components of control systems 11 may ensure accuracy. For example, control system 11 may determine the identity of an occupant by detecting mobile device 80 and actuating cameras 44, 48 because not all occupants may be identified with a mobile device 80 and/or the resolution of images captured by cameras 44, 48 may not enable identification of the occupant. The redundant nature of the components may also provide increased data acquisition. For example, after determining the identity of an occupant by sensing mobile device 80, controller 100 may actuate camera(s) 44, 48 to capture an image of the occupant. The image can be utilized at a later time point to determine the identity of the occupant.

Control system 11 may determine operating conditions 302-310 based on feature data 202-212. Controller system 11 may also be configured to generate an internal notification 402 and/or an external notification 404 based on determined operating conditions 302-310. Notifications 402-404 may be in any number of forms. For example, internal notifications 402 may include an indicator light on dashboard 30 or a vibrating motor (not shown) in seat 34, 36 to indicate occupants of vehicle 10 of the existence of one or more operating conditions 302-310. External notifications may include a generated message (e.g., email or text message) to an owner, a police department, or a public-safety answering point (PSAP), to indicate people outside of vehicle 10 of the existence of one or more operating conditions 302-310.

In some embodiments, control system 11 may enable notifications based on a data profile associated with the identified occupants. For example, controller 100 may retrieve feature data 208 indicative of the identity of the occupants. Controller 100 may also access the data profile (e.g., through a look-up chart) to determine conditions that may be enabled. For example, based on feature data 208 indicating that the occupant (e.g., the driver) is a teenager, controller 100 may enable a determination of certain conditions (e.g., 302, 304, 310).

For example, control system 11 may be configured to determine a condition of erratic driving (e.g., condition 302). In some embodiments, controller 100 may receive feature data 208 indicative of an occupant status of vehicle 10. Based on the occupant status, controller 100 may retrieve feature data 202 and/or 204 to determine whether vehicle is operating within predetermined ranges. For example, controller 100 may be configured with storage unit 106 that holds a database of speed limits for roads in a certain geographical area. Positioning data of feature data 202 may be used to determine the specific geographic area vehicle 10 is located in. This geographic information may then be compared to the database of speed limits for that geographic area to determine the allowed speed limit of the road that vehicle 10 is traveling on. This information may be also used by the controller 100 to generate a notification based on vehicle 10 going faster than a speed limit or a predetermined threshold (e.g., x miles per hour above the speed limit). According to the positioning data of feature data 202, controller 100 may also determine whether vehicle 10 is conducting excessive braking, lane changes, and/or swerving. For example, controller 100 may determine a braking frequency expectation according to the local traffic at a current position of vehicle 10 based on feature data 202. Controller 100 may also be configured to determine the actual braking of vehicle by retrieving feature data 204. Controller 100 may then compare the braking frequency expectation to the actual braking in order to determine whether vehicle 10 is braking excessively. Controller 100 may also transmit notification 402, 404 based on the determined conditions.

In another example, control system 11 may be configured to determine an operating condition (e.g., 304-306) based on behavior of the occupant. For example, if the occupant of the vehicle is determined to be a teenager or elder, controller 100 may be configured to retrieve feature data 206 indicative of eye movement, feature data 202 indicative of positioning of vehicle 10, and/or feature data 204 indicative of the operation of vehicle 10. Based on the eye movement of the driver, controller 100 may be configured to determine whether the teenager is distracted, for example, texting while driving (e.g., condition 304). Controller 100 may similarly determine abnormal driving behavior of elderly people, for example, resulting from immediate health problems (e.g., condition 306). Other conditions determined by controller 100 based on feature data 206 may include dilated pupils, tiredness, dizziness, and/or extended periods of eye closure. Controller 100 may also be configured to compare the feature data 206 to feature data 202, 204 to provide richer context. For example, if the feature data 202 indicates vehicle 10 is swerving and feature data 206 indicates dilated pupils, controller 100 may indicate an urgent condition (e.g., drunken driving). Based on the determination of the conditions, controller 100 may be configured to generate and transmit a notification 402, 404. For example, if the driver's eyes close or leave the road for more than 2 seconds, notifications 402, 404 may be generated and transmitted.

In yet another example, control system 11 may be configured to determine an operating condition (e.g., 308) based on a child left in vehicle 10 unoccupied. In some embodiments, controller 100 may retrieve feature data 208 to determine whether there is a child occupying vehicle 10. In some embodiments, controller 100 may also retrieve feature data 204 to determine whether vehicle 10 is in park. Controller 100 may further retrieve feature data 210 to determine the presence of other occupants in vehicle 10. If it is determined that vehicle 10 is in park and the child is left unoccupied, controller 100 may be configured to generate and transmit notification 402, 404. For example, controller 100 may be configured to generate and transmit one or more notification(s) 404 to mobile device 80 of an owner of vehicle 10. If notification(s) 404 are not successful, controller 100 may send a notification 404 to a police station (e.g., 911) or PSAP.

In a further example, control system 11 may be configured to determine an operating condition (e.g., 310) of an occupant not wearing a seat belt while vehicle 10 is in motion. For example, controller 100 may retrieve data pertaining to the identity of the occupant from feature data 208, and only enable the determination for certain identified occupants (e.g., teenagers). Controller 100 may also receive operating conditions from one or more of feature data 202-204 and 208-212. For instance, controller may retrieve feature data 210 to determine the location of the occupant and feature data 212 to determine whether the seat belt is buckled. Controller 100 may further retrieve at least one of feature data 202, 204 to determine whether vehicle 10 is in motion. If one or more predetermined conditions are met, controller may generate a notification of an operating condition (e.g., 310). For example, controller 100 may be configured to actuate a vibrating motor (not shown) in seat 34, 36 to provide indication 402 to the occupant. Controller 100 may also transmit notification 404 to mobile device 80 outside of vehicle 10. The notification 404 to mobile device 80 may also include information, such as GPS location and speed.

In some embodiments, controller 100 may be configured to determine conditions 302-310 based on computer learning (e.g., predictive models). The predictive models may be trained using extracted feature data corresponding to known conditions. For example, cameras 44, 48 may capture an image, which may be processed with facial recognition software to extract the occupant's eye movement (e.g., feature data 206). The extraction of the eye movement may include processing data points corresponding to direction of the eyes of the driver. Controller 100 may train the predictive models using eye movements that correspond to known safe or unsafe conditions. Controller 100 may then apply the predictive models on extracted feature data 206 determine the presence of unsafe conditions, such as texting while driving (e.g., condition 304). The predictive models may be unique to each occupant, and may be continually updated with additional data and determined operations to enhance the accuracy of the determinations. In some embodiments, the predictive models can be trained with multiple feature data. The predictive model for condition 304 may be trained using feature data 204, 206, and 208.

In some embodiments, the conditions may be determined based on comparing the feature data with statistical distribution of history data of the feature data. For example, controller 100 may be configured to retrieve feature data 206 indicative of a current eye movement and correlate feature data 206 to a statistical distribution of previous determinations of a teenager texting while driving (e.g. condition 304). In some embodiments, controller 100 may then determine an accuracy rating that condition 306 is occurring based on the statistical distribution, and update the statistical distribution with the current feature data 206.

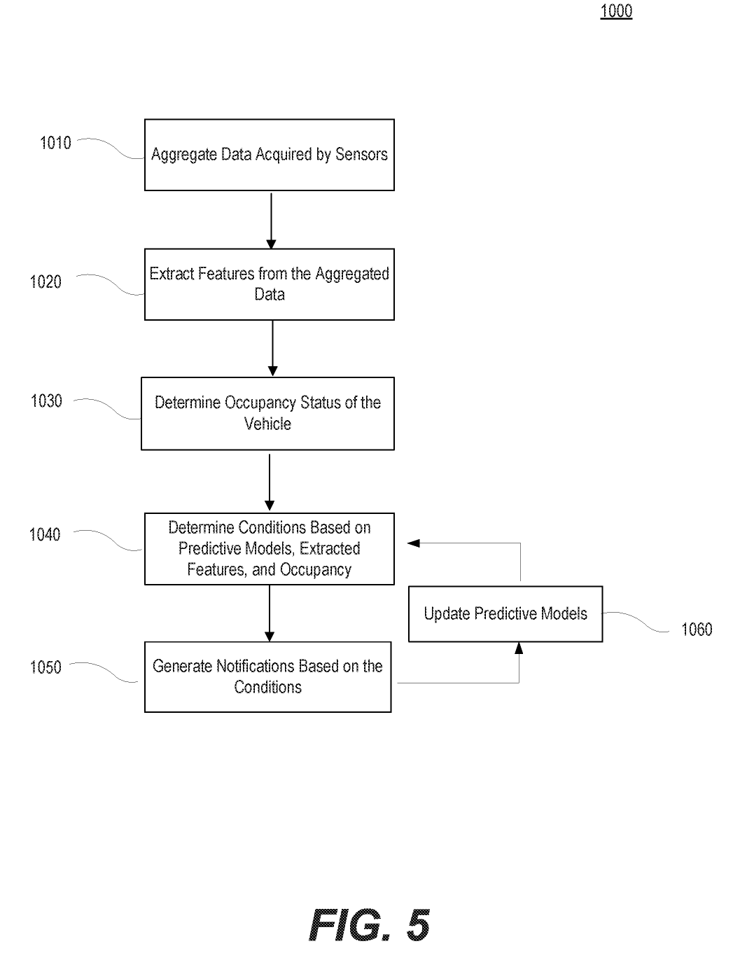

FIG. 5 is a flowchart illustrating an exemplary method 1000 that may be performed by exemplary system 11 of FIG. 3. For example, method 1000 may be performed by controller 100.

In Step 1010, one or more components of control system 11 may aggregate data acquired by sensors. Sensors may include any component configured to acquire data based on occupancy or operating status of vehicle 10. Sensors may include sensors 25-28, seat belt sensor 39, microphone 42, cameras 44, 48, and any other component configured to collect data of vehicle 10. The data may be aggregated into storage unit 106 and/or memory module 108. In some embodiments, controller 100 may aggregate a first set of data indicative of occupancy of vehicle 10 and a second set of data indicative of at least one operating status of vehicle 10. For example, the first set of data may include data related to eye movement of the driver, and the second set of data may include positioning data or operating data (e.g., from powertrain sensors 25-27).

In Step 1020, one or more components of control system 11 may extract feature data from the aggregated data. In some embodiments, controller 100 may aggregate data from cameras 44, 48 related to facial features of the occupants. Controller 100 may then process the data to extract data features 206 related to the eye movement of occupants. For example, controller 100 may determine the direction of the eye movement at time points (e.g., during operation of vehicle 10) and store the processed data into one of storage unit 106 and/or memory module 108. The aggregated data may be tagged according to the occupant and the type of data (e.g., eye movement). In some embodiments, controller 100 may be configured to receive geographic positioning data of vehicle 10 from satellite 110 and traffic data local to the current position of vehicle 10 from traffic station 112. Controller 100 may then extract an expectation of braking according to the local traffic of vehicle 10 and save the processed data in one of storage unit 106 and/or memory module 108.

In Step 1030, one or more components of control system 11 may determine an occupancy status of the vehicle. In some embodiments, controller 100 may determine occupancy status based on received data, such as biometric data, detection of mobile device 80, and/or images captured by cameras 44, 48. The determination may be based on redundant components to ensure accuracy and provide additional information related to the identity of the occupant.

In Step 1040, one or more components of control system 11 may determine conditions based on the extracted features and occupancy. In some embodiments, controller 100 may enable determination of conditions (e.g., 302-310) based on the identity of the occupant of vehicle 10. For example, if the occupant is determined to be a teenager, controller 100 may enable processing of certain conditions (e.g., 302, 304, 310). If one of the occupants is determined to be a child, controller may enable processing of certain conditions (e.g., 308).

In some embodiments, controller 100 may synthesize data/features of feature data 202-212 to determine the presence of any number of conditions (e.g., 302-310). For example, based on a determination that vehicle 10 is being operated by a teenager, controller 100 may determine whether the teenager is conducting excessive braking by comparing the braking expectation from feature data 202 to data indicating actual braking from feature data 204. In some embodiments, controller 100 may also utilize predictive models to determine the occurrence of conditions 302-310. For example, controller 100 may enter the extracted features into algorithms and compare the result to a predetermined range. If the eye movement falls within a range of normal (e.g., safe) behavior, controller 100 may not perform any additional steps. However, if the eye movement falls outside of the range, controller 100 may extract the feature indicating abnormal behavior and transmit the signal to controller 100.

In Step 1050, one or more components of control system 11 may generate notification 402, 404 based on the conditions (e.g., 302-310). For example, internal notifications 402 may include an indicator light on dashboard 30 or a vibrating motor (not shown) in seat 34, 36 to indicate occupants of vehicle 10 of the existence of one or more operating conditions 302-310. External notifications may include a generated message (e.g., email or text message) to an owner, a police department, or a PSAP, to indicate the existence of one or more operating conditions 302-310.

In Step 1060, one or more components of control system 11 may update the predictive models based on computer learning. For example, the predictive models may be updated based on comparing expected conditions to actual conditions. Control system 11 may also download updates for data and software for controller 100 through network 70 (e.g., the internet).

Another aspect of the disclosure is directed to a non-transitory computer-readable medium storing instructions which, when executed, cause one or more processors to perform the methods of the disclosure. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed control system and related methods. Other embodiments will be apparent to those skilled in the art from consideration of the specification and practice of the disclosed control system and related methods. It is intended that the specification and examples be considered as exemplary only, with a true scope being indicated by the following claims and their equivalents.

What is claimed is:

1. A system for detecting a condition associated with an occupant in a vehicle, the system comprising:
a plurality of sensors configured to acquire a first set of data indicative of occupancy of the vehicle and a second set of data indicative of at least one operating status of the vehicle; and
at least one controller configured to:
aggregate the first set of data and the second set of data;
automatically determine the condition associated with the occupant in the vehicle based on the aggregated data; and
generate a notification based on the condition.

2. The system of claim 1, wherein the at least one controller is further configured to extract features based on the aggregated data.

3. The system of claim 2, wherein the at least one controller is further configured to determine the condition based on the extracted features.

4. The system of claim 3,
wherein the condition is determined based on predictive models using the extracted features, and
wherein the predictive models are trained using training features corresponding to known conditions.

5. The system of claim 3, wherein the condition is determined based on comparing the extracted features with statistical distributions of history data of the extracted features.

6. The system of claim 1,
wherein the plurality of sensors include a camera configured to capture an image of an interior of the vehicle, and
wherein the first set of data is derived from the image.

7. The system of claim 1,
wherein the plurality of sensors include at least one sensor operatively connected to at least one of a powertrain and a braking system, and
wherein the second set of data is received from the at least one sensor.

8. The system of claim 1, wherein the at least one controller is configured to detect at least one of an age and an identity of the occupant.

9. The system of claim 8, wherein the condition is indicative of a minor occupant being left inside the vehicle alone.

10. The system of claim 8, wherein the condition is indicative of the occupant texting while operating the vehicle.

11. The system of claim 8, wherein the condition is indicative of a health condition of an elder occupant while operating the vehicle.

12. The system of claim 1, wherein the at least one controller is further configured to provide the notification to an external device wirelessly connected with the vehicle.

13. A method for detecting a condition associated with an occupant in a vehicle, the method comprising:
receiving a first set of data indicative of occupancy of the vehicle and a second set of data indicative of at least one operating status of the vehicle;
aggregating the first set of data and the second set of data;
automatically determining a condition associated with the occupant in the vehicle based on the aggregated data; and
generating a notification based on the condition.

14. The method of claim 13, further including extracting features based on the aggregated data, wherein the condition is determined based on the extracted features.

15. The method of claim 14, further including training the predictive models using training features corresponding to known conditions, wherein the condition is determined based on the predictive models using the extracted features.

16. The method of claim 14, wherein determining the condition includes comparing the extracted features with statistical distribution of history data of the extracted features.

17. The method of claim 13, further including detecting at least one of an age and an identity of the occupant.

18. The method of claim 17, wherein determining the condition is indicative of a minor occupant being left inside the vehicle alone.

19. The method of claim 17, wherein determining the condition is indicative of the occupant texting while operating the vehicle.

20. A vehicle, comprising:
a seat configured to accommodate an occupant;
a plurality of sensors configured to acquire a first set of data indicative of occupancy of the vehicle and a second set of data indicative of at least one operating status of the vehicle; and
at least one controller configured to:
aggregate the first and second sets of data;
automatically determine a condition associated with the occupant in the vehicle based on the aggregated data; and
generate a notification based on the condition.
